(19) United States
(12) Patent Application Publication
(10) Pub. No.: US 2025/0103055 A1
(43) Pub. Date: Mar. 27, 2025

(54) CONTROL SYSTEM, CONTROL METHOD, AND STORAGE MEDIUM

(71) Applicant: HONDA MOTOR CO., LTD., Tokyo (JP)

(72) Inventors: Sango Matsuzaki, Wako-shi (JP); Misa Komuro, Wako-shi (JP)

(21) Appl. No.: 18/884,166

(22) Filed: Sep. 13, 2024

(30) Foreign Application Priority Data
Sep. 27, 2023 (JP) 2023-166292

(51) Int. Cl. G05D 1/617; G05D 107/17; G06V 20/58

(52) U.S. Cl. CPC G05D 1/617; G06V 20/58; G05D 2107/17

(57) ABSTRACT

A control system is a control system that controls a mobile object moving autonomously in an area in which a pedestrian is able to move, and recognizes objects around the mobile object, identifies a candidate area that is an area in which the mobile object stops when a specific event occurs, refers to information on a plurality of candidate areas, identifies the candidate area that is the candidate area that is obtained by excluding the candidate area in which the object interferes from the plurality of candidate areas and that corresponds to a priority, and moves the mobile object to the identified candidate area.

### CROSS-REFERENCE TO RELATED APPLICATION

Priority is claimed on Japanese Patent Application No. 2023-166292, filed Sep. 27, 2023, the content of which is incorporated herein by reference.

### BACKGROUND

### Field of the Invention

The present invention relates to a control system, a control method, and a storage medium.

### Description of Related Art

Conventionally, robots that guide users to desired locations or transport luggage are known (Japanese Unexamined Patent Application, First Publication No. 2012-111011).

However, in the system described above, a stop position of a mobile object has not been fully considered.

The present invention has been made in consideration of these circumstances, and one of its objectives is to provide a control system, a control method, and a storage medium that can determine a stop position according to an environment.

### SUMMARY

The control system, the control method, and the storage medium according to the present invention have adopted the following configuration.
(1): A control system according to one aspect of the present invention is a control system that controls a mobile object moving autonomously in an area in which a pedestrian is able to move, and includes a storage medium configured to store computer-readable instructions, and one or more processors connected to the storage medium, in which the one or more processors execute the computer-readable instructions to recognize objects around the mobile object, identify a candidate area that is an area in which the mobile object stops when a specific event occurs, refer to information on a plurality of candidate areas, identify the candidate area that is obtained by excluding the candidate area in which the object interferes from the plurality of candidate areas and that corresponds to a priority, and move the mobile object to the identified candidate area.
(2): In the aspect of (1) described above, the one or more processors may execute the computer-readable instructions to refer to information on a plurality of candidate areas to which priorities have been assigned, which is stored by a storage unit, and identify the candidate area that is the candidate area that is obtained by excluding the candidate area in which the object interferes from the plurality of candidate areas and that corresponds to the priority.
(3): In the aspect of (1) described above, information on the candidate area may contain information on a priority of the candidate area, and the priority may be set on the basis of information provided by a device outside the mobile object, which is not mounted on the mobile object.
(4): In the aspect of (3) described above, information provided by a device outside the mobile object may be information on a past traffic flow for each of the candidate areas.
(5): In the aspect of (4) described above, the one or more processors may execute the computer-readable instructions to set a priority of the candidate area in which the past traffic flow is equal to or greater than a threshold value lower than a priority of the candidate area in which the past traffic flow is less than the threshold value.
(6): In the aspect of (5) described above, the one or more processors may execute the computer-readable instructions to set the priority on the basis of at least one item of a size of the mobile object relative to a size of an area corresponding to each of the candidate areas and a distance between a target that the mobile object is following and the candidate area, in addition to information on the past traffic flow.
(7): In the aspect of (6) described above, the one or more processors may execute the computer-readable instructions to set the priority of a corresponding candidate area to be higher as the candidate area is larger relative to the mobile object.
(8): In the aspect of (6) described above, the one or more processors may execute the computer-readable instructions to set the priority of a corresponding candidate area to be higher as the distance between the object and the candidate area is shorter.
(9): In the aspect of (6) described above, the one or more processors may execute the computer-readable instructions to exclude an area in which the past traffic flow is equal to or greater than a predetermined value from the candidate areas.
(10): In the aspect of (7) described above, the one or more processors may execute the computer-readable instructions to identify the candidate areas on the basis of the priority and one or both of a cost and a risk when the mobile object moves to each of the candidate areas.
(11): In the aspect of (1) described above, the mobile object may be capable of autonomously moving in an area in which vehicles are not able to move and pedestrians are able to move.
(12): A control method according to another aspect of the present invention includes, by a computer of a control system that controls a mobile object that moves autonomously in an area in which vehicles are not able to move and pedestrians are able to move, recognizing objects around the mobile object, identifying a candidate area that is an area in which the mobile object stops when a preset event occurs, referring to information on a plurality of candidate areas to which priorities have been assigned, which is stored by a storage unit, identifying the candidate area that is the candidate area that is obtained by excluding the candidate area in which the object interferes from the plurality of candidate areas and that corresponds to the priority, and moving the mobile object to the identified candidate area.
(13): A storage medium according to still another aspect of the present invention has stored a program causing a computer of a control system that controls a mobile object moving autonomously in an area in which vehicles are not able to move and pedestrians are able to move to execute processing of recognizing objects around the mobile object, processing of identifying a candidate area that is an area in which the mobile object stops when a preset event occurs, processing of referring to information on a plurality of candidate areas to which priorities have been assigned, which is stored by a storage unit, processing of identifying the candidate area that is the candidate area that is obtained by excluding the candidate area in which the object interferes from the plurality of candidate areas and that corresponds to the priority, and processing of moving the mobile object to the identified candidate area.

According to the aspects of (1) to (13), it is possible to determine a stop position according to an environment.

### BRIEF DESCRIPTION OF THE DRAWINGS

FIG. 1 is a diagram which shows an example of a configuration of a mobile object system including a mobile object.

FIG. 2 is a diagram for describing an example of a usage mode of the mobile object.

FIG. 3 is a diagram for describing a guidance mode.

FIG. 4 is a perspective view which shows the mobile object.

FIG. 5 is a diagram which shows an example of a functional configuration of the mobile object.

FIG. 6 is a diagram which shows an example of a functional configuration of an information providing device.

FIG. 7 is a diagram which shows an example of an image captured by an imaging unit.

FIG. 8 is a diagram which shows candidate areas for a stop position.

FIG. 9 is a diagram or describing an identification of a target area.

FIG. 10 is a diagram which shows an example of the candidate areas.

FIG. 11 is a diagram which shows an example of analysis information.

FIG. 12 is a diagram which shows an example of priority information.

FIG. 13 is a flowchart which shows an example of a flow of processing executed by the information providing device.

### DETAILED DESCRIPTION

Hereinafter, an embodiment of a control system, a control method, and a storage medium of the present invention will be described with reference to the drawings. The control system of a mobile object of the present invention controls a driving device of the mobile object to move the mobile object. The mobile object in the present invention autonomously moves in an area in which a pedestrian walks, leading a leading subject and following the subject. The mobile object can move in an area in which a pedestrian can move, even if a vehicle (a car, a motorcycle, a light vehicle) cannot move. The area in which a pedestrian can move is a sidewalk, a public open space, a floor in a building, or the like, and may also include a roadway. In the following description, it is assumed that a person is not riding on the mobile object, but a person may ride on the mobile object. The leading subject is, for example, a pedestrian, but may also be a robot or an animal. For example, the mobile object moves a little ahead of an elderly user while heading toward a predetermined destination point, so that other pedestrians who may be an obstacle to a movement of the user do not get too close to the user (that is, it operates to make a way for the user). The user is not limited to the elderly, and may be a person who tends to have difficulty walking, a child, a person shopping at a supermarket, a patient moving around in a hospital, a pet taking a walk, or the like. In addition, the mobile object may predict a direction in which the user will move and autonomously move in front of the user at the same moving speed of the user, without the user necessarily needing to have determined a destination point in advance. Note that such an operation may not be performed all the time, but may be performed temporarily. For example, when the mobile object travels alongside the user or follows the user and detects a specific situation (for example, presence of an obstacle or traffic congestion) in a traveling direction of the user, the mobile object may temporarily lead the user by executing an algorithm of the present invention.

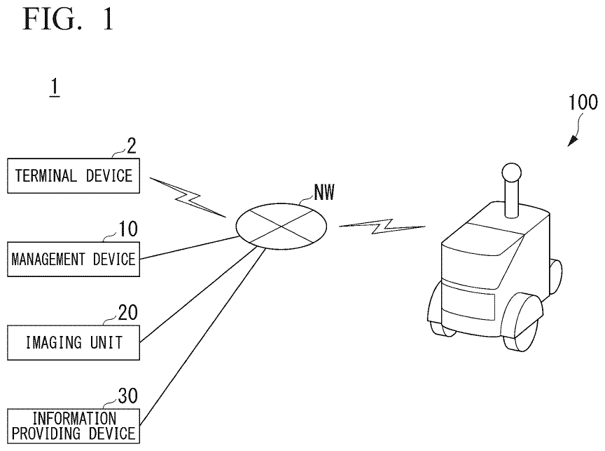

FIG. 1 is a diagram which shows an example of a configuration of a mobile object system 1 including a mobile object 100. The mobile object system (“control system”) 1 includes, for example, one or more terminal devices 2, a management device 10, one or more imaging units 20, an information providing device 30, and one or more mobile objects 100. These communicate, for example, via a network NW. The network NW is, for example, any network such as a LAN, a WAN, or an Internet line. Some of functional constituents included in the information providing device 30 may be mounted on the mobile object 100, and some of the functional constituents included in the mobile object 100 may be mounted on the information providing device 30.

### Terminal Device

The terminal device 2 is, for example, a computer device such as a smartphone or a tablet terminal. For example, the terminal device 2 requests for a provision of authority to use the mobile object 100 from the management device 10 on the basis of an operation of the user, or acquires information indicating that the use has been permitted.

### Management Device

The management device 10 grants the user of the terminal device 2 the authority to use the mobile object 100 in response to a request from the terminal device 2, or manages reservations for the use of the mobile object 100. For example, the management device 10 generates and manages schedule information in which identification information of a preregistered user is associated with a date and time of reservations for the use of the mobile object 100.

### Imaging Unit

The imaging unit 20 is a camera that captures images of a scene in a target area.

The imaging unit 20 provides the information providing device 30 with images captured at a specific interval.

### Information Providing Device

The information providing device 30 provides the mobile object 100 with a position of the mobile object 100, an area in which the mobile object 100 moves, and map information about an area surrounding the area. The information providing device 30 may generate a route to a destination of the mobile object 100 in response to a request from the mobile object 100, and provide the generated route to the mobile object 100. Details of the information providing device 30 will be described below.

### Mobile Object

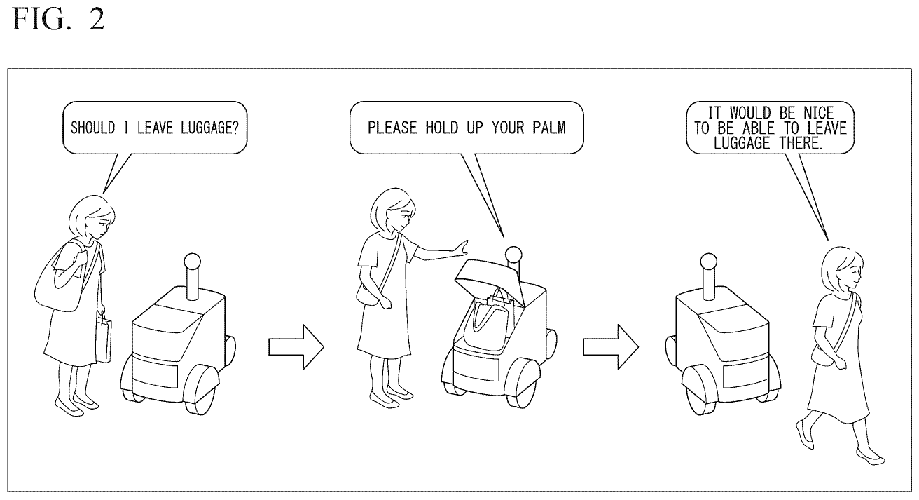

The mobile object 100 is used by a user in the following usage modes. FIG. 2 is a diagram for describing an example of the usage modes of the mobile object 100. The mobile object 100 can move autonomously in areas through which pedestrians can move. The mobile object 100 can pass through, for example, areas through which vehicles cannot pass. The mobile object 100 is disposed, for example, at a specific position in a facility or a town. When a user wants to use the mobile object 100, the user can start using the mobile object 100 by operating an operation unit (not shown) of the mobile object 100, or can start using the mobile object 100 by operating the terminal device 2. For example, when a user goes shopping and has a lot of luggage, the user starts using the mobile object 100 and puts the luggage in a storage section of the mobile object 100. The mobile object 100 then moves together with the user to autonomously follow the user. The user can continue shopping with the luggage stored in the mobile object 100, or move on to a next destination. For example, the mobile object 100 moves together with the user while moving on a sidewalk or a crosswalk on a roadway. The mobile object 100 can move in the areas through which pedestrians can pass, such as roadways and sidewalks. For example, the mobile object 100 may be used in indoor or outdoor facilities or private areas, such as shopping centers, airports, parks, and theme parks, and can move in areas through which pedestrians can pass.

The mobile object 100 may be capable of autonomously moving in modes such as a guidance mode and an emergency mode in addition to (or instead of) a following mode in which it follows a user as described above.

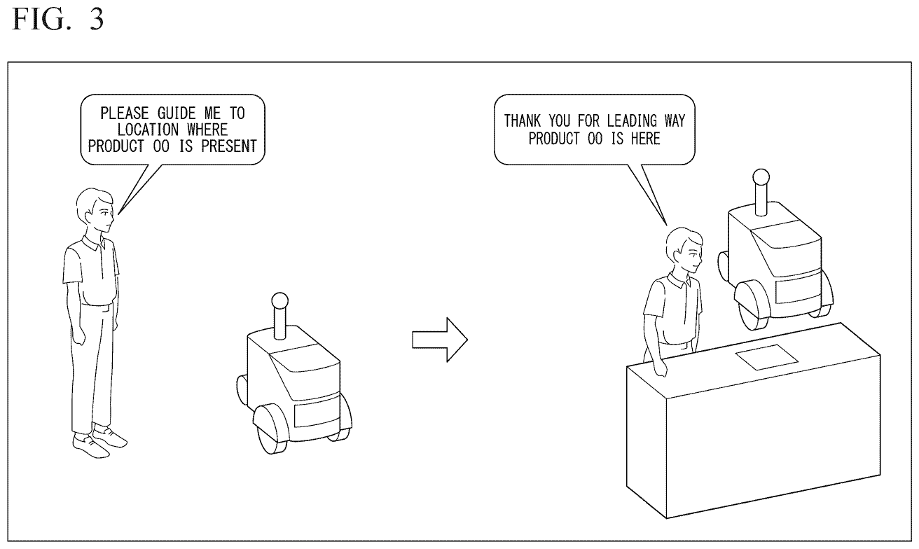

FIG. 3 is a diagram for describing the guidance mode. The guidance mode is a mode in which the mobile object guides the user to a destination designated by the user, and moves autonomously in front of the user at the same speed as a moving speed of the user to lead the user. As shown in FIG. 3, when a user is looking for a specific product in a shopping center and the user requests the mobile object 100 to lead the user to a location of the specific product, the mobile object 100 leads the user to the location of the product. As a result, the user can easily find the specific product. When the mobile object 100 is used in a shopping center, the mobile object 100 or the information providing device 30 stores information in which locations of products, locations of stores, locations of facilities in the shopping center, and the like are associated with map information, and map information of the shopping center. This map information includes detailed map information including widths of roads and passages, and the like.

The emergency mode is a mode in which the mobile object 100 moves autonomously to seek help from nearby people or facilities to help the user, when something unusual happens to the user (for example, when the user falls) while moving with the user. In addition to (or instead of) following or providing guidance as described above, the mobile object 100 may move while maintaining a close distance to the user.

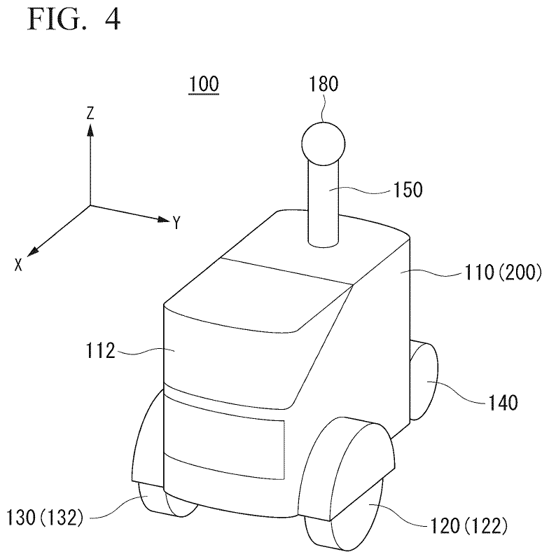

FIG. 4 is a perspective view which shows the mobile object 100. In the following description, a forward direction of the mobile object 100 is a plus x direction, a backward direction of the mobile object 100 is a minus x direction, a width direction of the mobile object 100, which is a left direction based on the plus x direction, is a plus y direction, a right direction is a minus y direction, and a height direction of the mobile object 100, which is orthogonal to the x and y directions, is a plus z direction.

The mobile object 100 includes, for example, a base body 110, a door section 112 provided on the base body 110, and wheels (a first wheel 120, a second wheel 130, and a third wheel 140) attached to the base body 110. For example, a user can open the door section 112 to put luggage into a storage section provided on the base body 110 or take luggage out of the storage section. The first wheel 120 and the second wheel 130 are driving wheels, and the third wheel 140 is an auxiliary wheel (driven wheel). The mobile object 100 may be able to move using a configuration other than wheels, such as an infinite trajectory.

A cylindrical support body 150 extending in the plus z direction is provided on a surface of the base body 110 in the plus z direction. A camera 180 that captures images of a vicinity of the mobile object 100 is provided at an end of the support body 150 in the plus z direction. A position at which the camera 180 is provided may be any position different from the position described above.

The camera 180 is, for example, a camera that can capture images of a vicinity of the mobile object 100 at a wide angle (for example, 360 degrees). The camera 180 may include a plurality of cameras. The camera 180 may be realized by combining, for example, a plurality of 120-degree cameras or a plurality of 60-degree cameras.

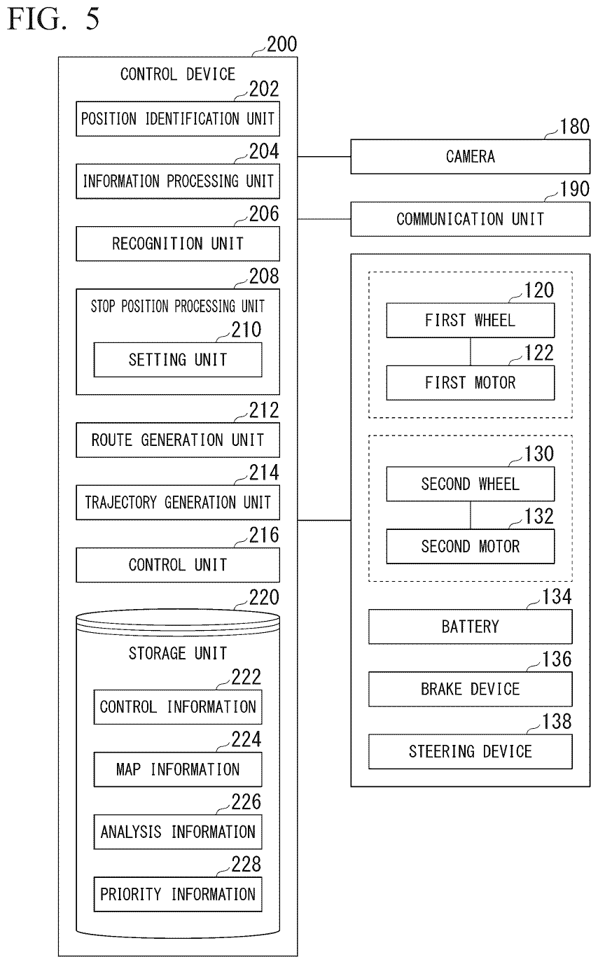

FIG. 5 is a diagram which shows an example of a functional configuration of the mobile object 100. In addition to the functional configuration shown in FIG. 4, the mobile object 100 further includes a first motor 122, a second motor 132, a battery 134, a brake device 136, a steering device 138, a communication unit 190, and a control device 200. The first motor 122 and the second motor 132 are operated by electricity supplied to the battery 134. The first motor 122 drives the first wheel 120, and the second motor 132 drives the second wheel 130. The first motor 122 may be an in-wheel motor provided on a wheel of the first wheel 120, and the second motor 132 may be an in-wheel motor provided on a wheel of the second wheel 130.

The brake device 136 outputs a brake torque to each wheel on the basis of an instruction from the control device 200. The steering device 138 includes an electric motor. The electric motor, for example, applies a force to a rack and pinion mechanism on the basis of an instruction from the control device 200 to change a direction of the first wheel 120 or the second wheel 130, and to change a course of the mobile object 100.

The communication unit 190 is a communication interface for communicating with the terminal device 2, the management device 10, or the information providing device 30.

### Control Device

The control device 200 includes, for example, a position identification unit 202, an information processing unit 204, a recognition unit 206, a stop position processing unit 208, a route generation unit 212, a trajectory generation unit 214, a control unit 216, and a storage unit 220. The position identification unit 202, the information processing unit 204, the recognition unit 206, the route generation unit 212, the trajectory generation unit 214, and the control unit 216 are realized by, for example, a hardware processor such as a central processing unit (CPU) executing a program (software). Some or all of these components may be realized by hardware (a circuit unit; including circuitry) such as a large scale integration (LSI), an application specific integrated circuit (ASIC), a field-programmable gate array (FPGA), or a graphics processing unit (GPU), or may be realized by software and hardware in cooperation. The program may be stored in advance in a storage device (a storage device with a non-transient storage medium) such as a hard disk drive (HDD) or flash memory, or may be stored in a removable storage medium (non-transient storage medium) such as a DVD or CD-ROM, and installed by mounting the storage medium in a drive device. The storage unit 220 is realized by a storage device such as an HDD, flash memory, or a random access memory (RAM). The stop position processing unit 208 is an example of an “identification unit.”

The storage unit 220 stores control information 222, which is a control program for controlling a behavior of the mobile object 100 referenced by the control unit 216, map information 224, analysis information 226, and priority information 228. The map information 224 is, for example, map information on a position of the mobile object 100 provided by the information providing device 30, an area in which the mobile object 100 moves, a surrounding area of the area, and the like. The analysis information 226 is analysis information 54 provided by the information providing device 30 (to be described below). The priority information 228 is information in which an area in which the mobile object 100 stops is associated with a priority. Some or all of the functional constituents included in the control device 200 may be included in another device. For example, the mobile object 100 and the other device may communicate and cooperate with each other to control the mobile object 100.

The position identification unit 202 identifies a position of the mobile object 100. The position identification unit 202 acquires position information of the mobile object 100 by a global positioning system (GPS) device (not shown) embedded in the mobile object 100. The position information may be, for example, two-dimensional map coordinates or latitude and longitude information. The position identification unit 202 may also estimate the position of the mobile object 100 at the same time as creating an environmental map by using a camera image captured by the camera 180 or a method such as a so-called SLAM using a sensor such as Lidar.

The information processing unit 204 manages information acquired from, for example, the terminal device 2, the management device 10, or the information providing device 30.

The recognition unit 206 recognizes positions (a distance from the mobile object 100 and a direction with respect to the mobile object 100) of objects around the mobile object 100, and states such as speeds and accelerations thereof on the basis of, for example, an image captured by the camera 180. The objects include traffic participants and obstacles within facilities and on roads. The recognition unit 206 recognizes and tracks a user of the mobile object 100. For example, the recognition unit 206 tracks the user on the basis of an image (for example, a facial image of the user) in which the user registered when the user uses the mobile object 100 is captured, or the facial image of the user (or features obtained from the facial image of the user) provided by the terminal device 2 or management device 10. The recognition unit 206 recognizes gestures made by the user. The mobile object 100 may be provided with a detection unit that is different from a camera, such as a radar device or LIDAR. In this case, the recognition unit 206 recognizes a surrounding situation of the mobile object 100 using a result of detection by the radar device or LIDAR instead of (or in addition to) the image.

The stop position processing unit 208 identifies a candidate area, which is an area in which the mobile object stops after a predetermined task is completed. The stop position processing unit 208 includes a setting unit 210. The setting unit 210 sets a priority for the candidate area. Processing of the stop position processing unit 208 and the setting unit 210 will be described in detail below.

The route generation unit 212 generates a route to a destination designated by a user. The destination may be a location of a product or a location of a facility. In this case, the user designates a product or facility, and thereby the mobile object 100 sets the location of the designated product or facility as the destination. The route is a route that can reach the destination rationally. For example, a distance to the destination, a time to reach the destination, an ease of travel of the route, and the like are scored, and a route is derived in which each score and a combined score of each score are equal to or greater than a threshold value.

The trajectory generation unit 214 generates a trajectory that the mobile object 100 needs to travel in the future on the basis of, for example, a gesture of the user, a destination set by the user, surrounding objects, a position of the user, and the like. The trajectory generation unit 214 generates a trajectory that allows the mobile object 100 to move smoothly to a target point. The trajectory generation unit 214 generates a trajectory according to a behavior of the mobile object 100 on the basis of, for example, a corresponding relationship between a predetermined gesture and a behavior, or generates a trajectory for heading toward a destination while avoiding surrounding objects. The trajectory generation unit 214 generates, for example, a trajectory for following a user being tracked or a trajectory for leading a user. The trajectory generation unit 214 generates, for example, a trajectory according to the behavior based on a preset mode. The trajectory generation unit 214 generates a plurality of trajectories according to the behavior of the mobile object 100, calculates a risk for each trajectory, and when a total value of the calculated risks and a risk of each trajectory point meet a preset criterion (for example, when the total value is equal to or less than a threshold value Th1 and the risk of each trajectory point is equal to or less than a threshold value Th2), adopts a trajectory that meets the criterion as a trajectory along which the mobile object 100 moves. For example, the risk tends to be higher as a distance between the trajectory (a trajectory point of the trajectory) and an obstacle is smaller, and to be lower as the distance between the trajectory and the obstacle is greater.

The control unit 216 controls the motors (the first motor 122, the second motor 132), the brake device 136, and the steering device 138 so that the mobile object 100 travels along a trajectory that meets a criterion set in advance.

### Information Providing Device

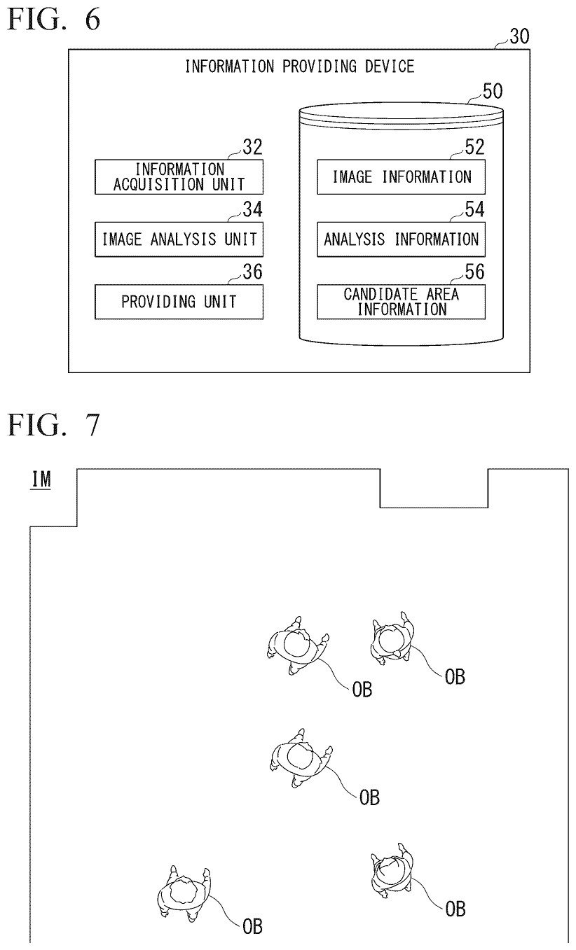

FIG. 6 is a diagram which shows an example of a functional configuration of the information providing device 30. The information providing device 30 includes, for example, an information acquisition unit 32, an image analysis unit 34, and a providing unit 36. Some or all of these functional units are realized by, for example, a hardware processor such as a CPU executing a program (software). Some or all of these components may be realized by hardware (circuit unit; including circuitry) such as an LSI, ASIC, FPGA, or GPU, or may be realized by software and hardware in cooperation. The program may be stored in advance in a storage device such as an HDD or flash memory (a storage device with a non-transient storage medium), or may be stored in a removable storage medium such as a DVD or CD-ROM (a non-transient storage medium) and may be installed by attaching the storage medium to a drive device. The storage unit 50 is realized by a storage device such as an HDD, flash memory, or RAM. The storage unit 50 stores image information 52, analysis information 54, candidate area information 56 (to be described below), and the like. The image information 52 is information on an image captured by the imaging unit 20. The analysis information 54 is information on results of processing by the image analysis unit 34.

The information acquisition unit 32 acquires the image captured by the imaging unit 20. FIG. 7 is a diagram which shows an example of an image IM captured by the imaging unit 20. In the example of FIG. 7, the imaging unit 20 is installed on a ceiling and captures the ground from the ceiling, but the present invention is not limited to this, and the imaging unit 20 may be installed in a position where it can capture the ground side from diagonally above and capture the ground from diagonally above. The image IM is, for example, an image of a specific area and an object OB (person) included in the specific area.

The image analysis unit 34 recognizes, for example, an object in an image on the basis of the image captured by the imaging unit 20. The image analysis unit 34 repeats this processing (repeats for each image in time series), derives a degree to which an object OB is present in each area, and generates the analysis information 54 that indicates the degree to which an object is present in each area. This analysis information 54 is information that indicates a past traffic flow in each area, such as a heat map that indicates a degree to which an object has been present in each area in the past.

The providing unit 36 provides the mobile object 100 with the analysis information 54.

### Control According to Priority

The control device 200 refers to information on a plurality of candidate areas, identifies a candidate area that is a candidate area that is obtained by excluding a candidate area in which an object interferes from the plurality of candidate areas and that corresponds to a priority, and moves the mobile object 100 to the identified candidate area. The priority may be identified on the basis of the priority information 228 as described below, or may be identified on the basis of a predetermined criterion. For example, the priority of the candidate area is identified on the basis of information on the candidate area, such as a past traffic flow, a current traffic flow in or near the candidate area, a size of the candidate area, a distance to a target (the current position of the mobile object 100 or the position of the user) relative to the candidate area, or a combination of these, and the candidate area is identified. Specifically, the control device 200 identifies the candidate area by, for example, referring to the priority information 228. The mobile object can move autonomously in an area in which vehicles cannot move and pedestrians can move. The priority is set on the basis of information provided by a device outside the mobile object 100 (for example, the information providing device 30) that is not mounted on the mobile object 100. The information provided by the device outside the mobile object 100 is information on past traffic flow for each candidate area. This processing will be described below.

The stop position processing unit 208 identifies a stop area, which is a position where the mobile object stops when a specific event occurs. The specific event is a task designated by the user, an instruction by the user, or the like. The task is a designated task, such as a task to guide the user to a specific position. The instruction by the user is a voice instruction such as “wait for a moment” or an instruction in response to an operation of designating waiting. The stop position processing unit 208 identifies, for example, a stop area in which the mobile object stops after an event is completed and before a next event occurs. A completion of an event means that a task designated by the user has been completed.

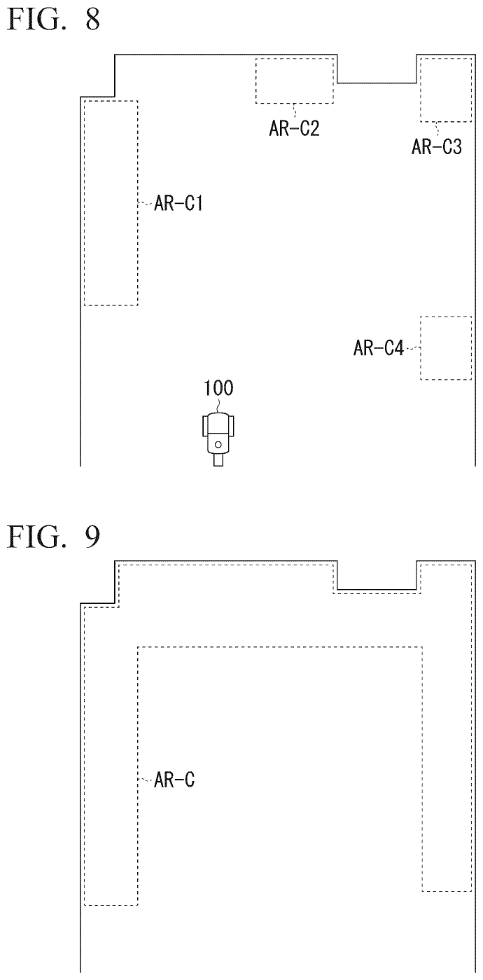

FIG. 8 is a diagram which shows candidate areas for a stop position. For example, as shown in FIG. 8, candidate areas AR-C1 to AR-C4 are candidate areas. This candidate areas AR-C1 to AR-C4 may be information managed by the mobile object 100, or may be information provided by the information providing device 30. For example, the information providing device 30 provides the mobile object 100 with candidate area information according to the position information of the mobile object 100 contained in the candidate area information 56. The provided candidate area information is information in which a position of a candidate area is associated with the priority of the candidate area.

Note that the candidate area may be identified by the stop position processing unit 208 of the mobile object 100. The stop position processing unit 208 identifies one or more target areas. FIG. 9 is a diagram for describing the identification of a target area. A target area is, for example, a position at which stopping of the mobile object 100 is unlikely to impede a movement of the object. In the example of FIG. 9, an area AR-C near a wall is identified as a target area. The stop position processing unit 208 may identify the wall as a target area as described above, or may identify all areas in the image as target areas. When all areas are set as candidate areas, processing of the stop position processing unit 208 is performed on all the areas (or areas other than the wall).

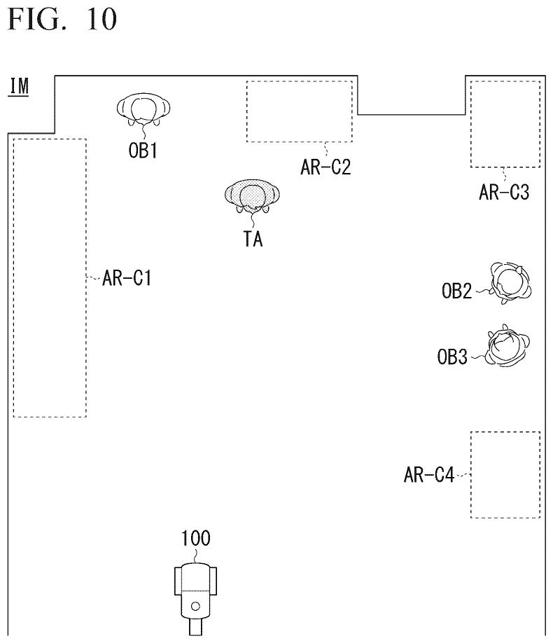

The stop position processing unit 208 identifies candidate areas within a target area in which the mobile object 100 can stop, on the basis of the target area and a recognized object. A candidate area is a position within the target area in which no object or user is present. FIG. 10 is a diagram which shows an example of a candidate area. In the example of FIG. 10, candidate areas AR-C1, AR-C2, AR-C3, and AR-C4 are identified. In this manner, a candidate area may be identified by the mobile object 100, or information on the candidate area may be provided by the information providing device 30 as described above. In FIG. 10, “TA” is a user who uses the mobile object 100.

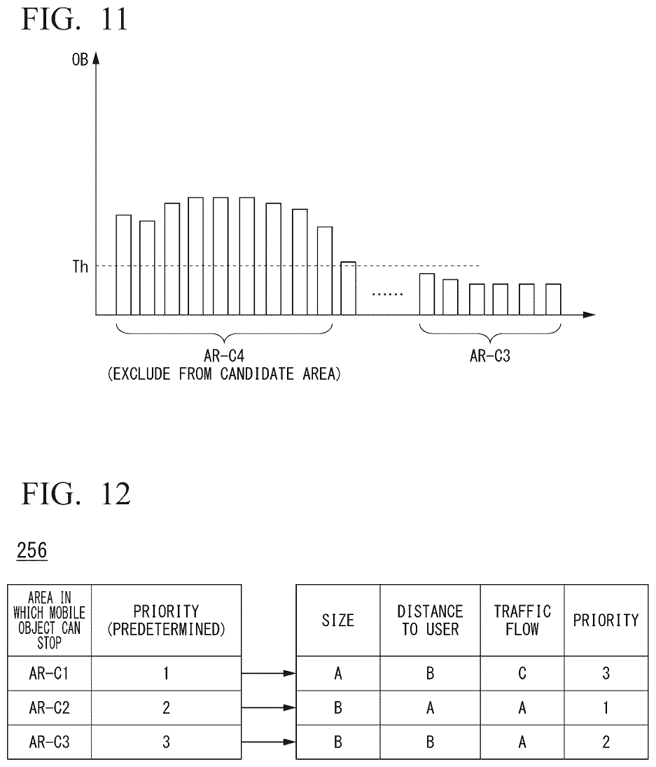

The setting unit 210 identifies an area within the candidate area in which a traffic flow is less than a threshold value, on the basis of the analysis information 226. FIG. 11 is a diagram which shows an example of the analysis information 226. FIG. 11 is an example of a graph which shows a degree of presence of an object in each area during a specific period of time. The vertical axis shows a degree of presence of an object, and the horizontal axis shows a position of an area. The setting unit 210 performs statistical processing on the position of an object for each image to derive the degree of presence of an object for each position. In the example of FIG. 11, the area AR-C4 is an area in which the degree of presence of an object is equal to or greater than a threshold value. The setting unit 210 excludes the area AR-C4 from the candidate area. This processing is an example of processing of “excluding an area in which the past traffic flow is equal to or greater than a specific value from the candidate area.” This processing is an example of processing of “setting a priority of a candidate area in which the past traffic flow is equal to or greater than a threshold value to a lower priority than a priority of a candidate area in which the past traffic flow is less than the threshold value.”

The setting unit 210 evaluates the candidate area on the basis of a specific criterion. FIG. 12 is a diagram which shows an example of the priority information 228. The setting unit 210 evaluates a predetermined priority on the basis of the specific criterion and modifies the priority. The specific criterion is, for example, a size of a candidate area, a distance between a candidate area and a user, and a traffic flow in a candidate area.

For example, as a candidate area is larger, the setting unit 210 makes an evaluation of a target candidate area higher. At this time, the size of the mobile object 100 may be taken into consideration. For example, the evaluation may be determined depending on how large the candidate area is relative to the size of the mobile object 100. For example, as the candidate area is larger relative to the size of the mobile object 100, the setting unit 210 makes the evaluation higher. As a distance between the candidate area and the user is closer, the setting unit 210 makes the evaluation higher. The setting unit 210 makes the evaluation higher as the past traffic flow of the candidate area is lower, and makes the evaluation lower as the past traffic flow of the candidate area is higher. Processing of lowering the evaluation according to the traffic flow is another example of processing of “setting a priority of the candidate area in which the past traffic flow is equal to or higher than a threshold value to a lower priority than a priority of the candidate area in which the past traffic flow is less than the threshold value.”

As described above, the setting unit 210 evaluates candidate areas for each criterion and performs statistical processing on results of the evaluation. The setting unit 210 evaluates the candidate areas on the basis of a result of the statistical processing, and assigns (modifies) a priority to the candidate areas. For example, a higher priority is assigned (modified) to the candidate areas in descending order of the evaluation. In the example of FIG. 12, the evaluation is highest in an order of candidate areas AR-C2, AR-C3, and AR-C1.

### Flowchart

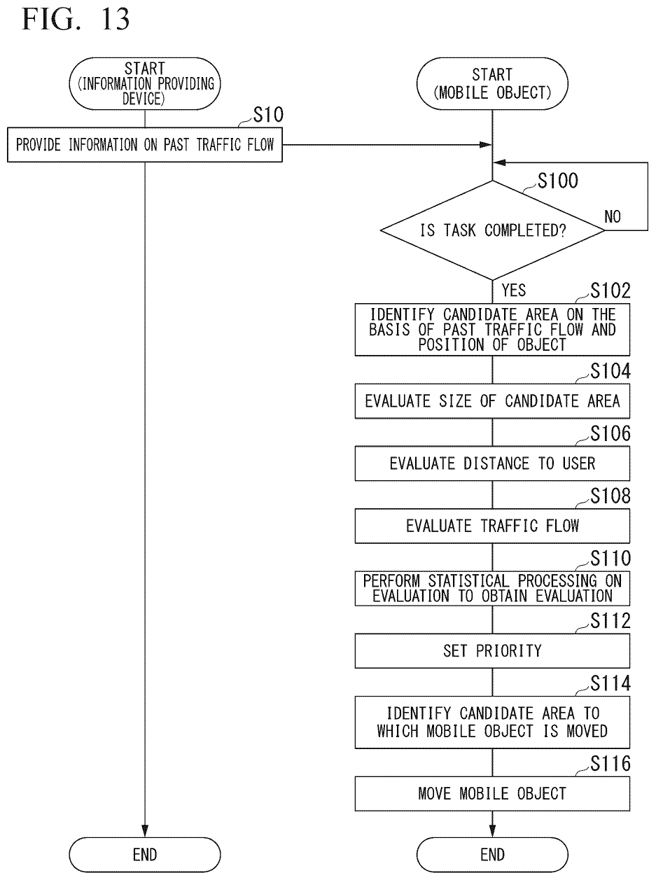

FIG. 13 is a flowchart which shows an example of a flow of processing executed by the information providing device 30. The processing of this flowchart is executed immediately before the mobile object 100 completes a task. The processing of this flowchart may be started at a timing when the task is completed or immediately after the task is completed.

First, the information providing device 30 provides the mobile object 100 with information on a past traffic flow (the analysis information 54) (step S10). This allows the stop position processing unit 208 to acquire the information on a past traffic flow. This processing may be executed at any timing.

Next, the stop position processing unit 208 determines whether it is a timing for the task to be completed (S100). When it is a timing for the task to be completed, the stop position processing unit 208 identifies candidate areas on the basis of the past traffic flow and a position of an object (step S100). As described above, the candidate areas AR-C1, AR-C2, and AR-C3 are identified.

Next, the setting unit 210 evaluates each of the size of a candidate area, the distance between a candidate area and a user, and the traffic flow in a candidate area (steps S104, S106, and S108). The setting unit 210 performs statistical processing on each evaluation to obtain an evaluation (step S110), and sets a priority for a candidate area (step S112). Next, the control unit 216 identifies a candidate area with a high priority (step S114) and moves the mobile object 100 to the identified candidate area (step S116). As a result, processing of one routine of the flowchart is completed. After that, when a task is set and an event occurs, the mobile object 100 starts moving from a position where it is stopped.

As described above, the mobile object 100 can respond stably and robustly to a situation by combining static information (information on the past traffic flow) and dynamic information (information on the recognized area). For example, a location where no traffic participants such as people are passing through is identified as a stop position, and the mobile object 100 can automatically stop at the stop position. In this manner, the mobile object 100 can determine a stop position according to an environment and stop there.

The stop position processing unit 208 may identify a candidate area on the basis of the priority described above and one or both of a cost and a risk when the mobile object 100 moves into each candidate area. The setting unit 210 may adjust the priority on the basis of scores such as an ease of moving into each candidate area and an ease of stopping. For example, the setting unit 210 may lower the priority of a candidate area whose score is equal to or less than a threshold value, or raise the priority of a candidate area whose score exceeds the threshold value. For example, the setting unit 210 causes the trajectory generation unit 214 to generate trajectories to each candidate area, evaluate each trajectory, and derive a score. For example, the score is derived on the basis of the risk when the mobile object moves along the trajectory, a length of the trajectory, or the cost when the mobile object moves along the trajectory. For example, the cost increases as the trajectory is straighter, and the risk decreases as a proximity to an object when the mobile object moves along the trajectory is further.

As described above, the mobile object 100 determines a position where it will wait after a task is completed, and moves to the determined position. As a result, the mobile object 100 can determine a stop position according to an environment, and wait at that stop position until a task is started. This position can be expected to relatively contribute to smooth traffic without restricting a behavior of a user who uses a target area.

In the example described above, the mobile object 100 has been described as one performing evaluation and setting a priority on the basis of the past traffic flow provided by the information providing device 30. Some of the processing performed by the mobile object 100 may be executed by the information providing device 30. For example, the information providing device 30 may execute some of the processing of the mobile object 100 in FIG. 13 described above. For example, the information providing device 30 may execute processing for setting the priority executed by the mobile object 100. In this case, the information providing device 30 and the mobile object 100 may cooperate to set the priority. For example, the information providing device 30 and the mobile object 100 may transmit and receive information to and from each other, use the transmitted and received information to execute processing for which they are responsible, and a system including the information providing device 30 and the mobile object 100 may determine the priority or move the mobile object 100.

According to the embodiment described above, the control device 200 identifies a candidate area that is an area in which the control device 200 will stop after a preset task is completed, refers to information on a plurality of candidate areas to which priorities have been assigned, which is stored by the storage unit, identifies a candidate area that is a candidate area that is obtained by excluding a candidate area in which an object interferes from the plurality of candidate areas and that corresponds to a priority, and moves the mobile object 100 to the identified candidate area, thereby determining a stop position according to an environment.

The embodiment described above can be expressed as follows.

A control system includes a storage medium for storing computer-readable instructions, and one or more processors connected to the storage medium, wherein the one or more processors executes the computer-readable instructions to control a mobile object that moves autonomously in an area in which a pedestrian can move, recognize objects around the mobile object, identify a candidate area in which the mobile object will stop when a specific event occurs, refer to information on a plurality of candidate areas, and identify the candidate area that is the candidate area that is obtained by excluding the candidate area in which the object interferes among the plurality of candidate areas, and that corresponds to a priority.

The form for carrying out the present invention has been described using an embodiment, but the present invention is not limited to such an embodiment, and various modifications and substitutions can be made within a range not departing from the gist of the present invention.

What is claimed is:

1. A control system that controls a mobile object moving autonomously in an area in which a pedestrian is able to move, comprising:
a storage medium configured to store computer-readable instructions; and
one or more processors connected to the storage medium,
wherein the one or more processors execute the computer-readable instructions to
recognize objects around the mobile object,
identify a candidate area that is an area in which the mobile object stops when a specific event occurs,
refer to information on a plurality of candidate areas,
identify the candidate area that is the candidate area that is obtained by excluding the candidate area in which the object interferes from the plurality of candidate areas and that corresponds to a priority, and
move the mobile object to the identified candidate area.

2. The control system according to claim 1,
wherein the one or more processors execute the computer-readable instructions to
refer to information on a plurality of candidate areas to which priorities have been assigned, which is stored by a storage unit, and
identify the candidate area that is the candidate area that is obtained by excluding the candidate area in which the object interferes from the plurality of candidate areas and that corresponds to the priority.

3. The control system according to claim 1,
wherein information on the candidate area contains information on a priority of the candidate area, and the priority is set on the basis of information provided by a device outside the mobile object, which is not mounted on the mobile object.

4. The control system according to claim 3,
wherein information provided by a device outside the mobile object is information on a past traffic flow for each of the candidate areas.

5. The control system according to claim 4,
wherein the one or more processors execute the computer-readable instructions to set a priority of the candidate area in which the past traffic flow is equal to or greater than a threshold value lower than a priority of a candidate area in which the past traffic flow is less than the threshold value.

6. The control system according to claim 5,
wherein the one or more processors executes the computer-readable instructions to set the priority on the basis of at least one of a size of the mobile object relative to a size of an area corresponding to each of the candidate areas and a distance between a target that the mobile object is following and the candidate area, in addition to information on the past traffic flow.

7. The control system according to claim 6,
wherein the one or more processors execute the computer-readable instructions to set the priority of a corresponding candidate area to be higher as the candidate area is larger relative to the mobile object.

8. The control system according to claim 6,
wherein the one or more processors execute the computer-readable instructions to set the priority of a corresponding candidate area to be higher as the distance between the object and the candidate area is shorter.

9. The control system according to claim 6,
wherein the one or more processors execute the computer-readable instructions to exclude an area in which the past traffic flow is equal to or greater than a predetermined value from the candidate areas.

10. The control system according to claim 7,
wherein the one or more processors execute the computer-readable instructions to identify the candidate areas on the basis of the priority and one or both of a cost and a risk when the mobile object moves to each of the candidate areas.

11. The control system according to claim 1,
wherein the mobile object is capable of autonomously moving in an area in which vehicles are not able to move and pedestrians are able to move.

12. A control method comprising:
by a computer of a control system that controls a mobile object that moves autonomously in an area in which vehicles are not able to move and pedestrians are able to move,
recognizing objects around the mobile object;
identifying a candidate area that is an area in which the mobile object stops after a preset task is completed;
referring to information on a plurality of candidate areas to which priorities have been assigned, which is stored by a storage unit;
identifying the candidate area that is the candidate area that is obtained by excluding the candidate area in which the object interferes from the plurality of candidate areas and that corresponds to the priority; and
moving the mobile object to the identified candidate area.

13. A non-transitory computer storage medium that has stored a program causing a computer of a control system that controls a mobile object moving autonomously in an area in which vehicles are not able to move and pedestrians are able to move to execute
processing of recognizing objects around the mobile object,
processing of identifying a candidate area that is an area in which the mobile object stops after a preset task is completed,
processing of referring to information on a plurality of candidate areas to which priorities have been assigned, which is stored by a storage unit,
processing of identifying the candidate area that is the candidate area that is obtained by excluding the candidate area in which the object interferes from the plurality of candidate areas and that corresponds to the priority, and
processing of moving the mobile object to the identified candidate area.
